(19) United States
(12) Patent Application Publication
(10) Pub. No.: US 2025/0205653 A1
(43) Pub. Date: Jun. 26, 2025

(54) Gas Separation Membranes

(71) Applicants: Fujifilm Manufacturing Europe B.V., Tilburg (NL); Fujifilm Corporation, Tokyo (JP)

(72) Inventors: Serguei Alexandrovich Starostine, Tilburg (NL); Erik Antonius Maria Vermeer, Tilburg (NL)

(21) Appl. No.: 18/850,188

(22) PCT Filed: Mar. 21, 2023
(86) PCT No.: PCT/EP2023/057161

§ 371 Date: Sep. 24, 2024

(30) Foreign Application Priority Data
Mar. 29, 2022 (GB) 2204427.5

(51) Int. Cl. B01D 69/12; B01D 53/22; B01D 67/00; B01D 69/02; B01D 69/10

(52) U.S. Cl. CPC B01D 69/1216; B01D 53/228; B01D 67/00791; B01D 69/02; B01D 69/107; B01D 2325/04

(57) ABSTRACT

A gas separation membrane comprising the following layers: (ii) a support layer; (ii) a discriminating layer; (iii) a further layer, wherein the further layer comprises groups of Formula (1): M-(O—)ₓ wherein: each M independently is a metal or metalloid atom; O is an oxygen atom; and each x independently has a value of at least 4; and (iv) optionally a protective layer; wherein: (a) the support layer (i) and the further layer (iii) are on opposite sides of discriminating layer (ii); and (b) the further layer (iii) comprises 1.5 to 10 atomic % of M of Formula (1) groups, wherein M is as hereinbefore defined.

This invention relates to gas separation membranes (GSMs) and to their preparation and use.

Gas separation membranes typically comprise a support (to provide mechanical strength) and a discriminating layer to distinguish between the gases to be separated. Often a protective layer is included on top of the discriminating layer in order to protect the discriminating layer from mechanical damage, e.g. during membrane handling and use. Damage to the discriminating layer can have undesirable consequences such as significantly reducing the selectivity of the GSM.

Typically protective layers comprise a polysiloxane and are formed on the discriminating layer by a wet chemical coating process.

While protective layers comprising a polysiloxane are useful for shielding the discriminating layer from damage, they also significantly reduce the gas permeance of the GSM. There is a need for GSMs comprising both a protective layer and good gas permeance.

According to a first aspect of the present invention there is provided a gas separation membrane comprising the following layers:
(i) a support layer;
(ii) a discriminating layer;
(iii) a further layer, wherein the further layer comprises groups of Formula (1):

M-(O—)ₓ Formula (1)
wherein:
   each M independently is a metal or metalloid atom;
   O is an oxygen atom; and
   each x independently has a value of at least 4; and
(iv) optionally a protective layer;
   wherein:
(a) the support layer (i) and the further layer (iii) are on opposite sides of discriminating layer (ii); and
(b) the further layer (iii) comprises 1.5 to 10 atomic % of M of Formula (1) groups, wherein M is as hereinbefore defined.

In this specification, the term “comprising” is to be interpreted as requiring the presence of the stated parts, steps or components, but does not exclude the presence of one or more additional parts, steps or components. Reference to an item by the indefinite article “a” or “an” does not exclude the possibility that more than one of the item(s) is present, unless the context clearly requires that there be one and only one of the items. The indefinite article “a” or “an” thus usually means “at least one”. The optional gutter layer is often abbreviated to “GL”, the discriminating or separation layer (ii) is often abbreviated to “DL” and the optional protective layer (iv) is often abbreviated to “PL”.

In the present specification, the separation or discriminating layer (ii) indicates a layer having a separation selectivity. A layer having a separation selectivity indicates a layer in which a ratio (P_{CO2}/P_{CH4}) of a permeability coefficient (P_{CO2}) of carbon dioxide to a permeability coefficient (P_{CH4}) of methane, in a case where a membrane having a thickness of 0.05 to 30 μm is formed and pure gas of carbon dioxide (CO₂) and methane (CH₄) is supplied to the obtained membrane at a temperature of 40° C. by setting the total pressure of the gas supply side to 0.5 MPa, is 10 or greater.

### BRIEF DESCRIPTION OF THE DRAWINGS

In the accompanying drawing:

FIG. 1(a) is a schematic vertical sectional view showing gas separation membrane (10) comprising a support layer (i) (1), a discriminating layer (ii) (2) and a further layer (iii) (3).

FIG. 1(b) is identical to FIG. 1(a) except that the GSM further comprises a protective layer (iv) (4).

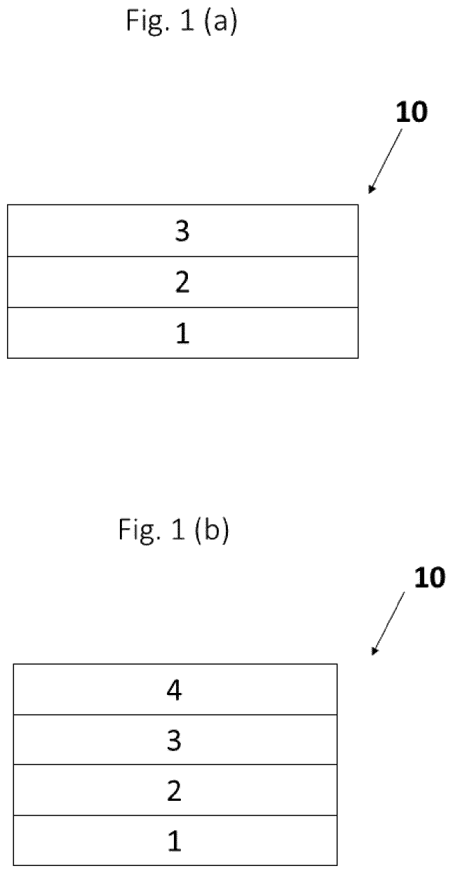

In both FIG. 1(a) and FIG. 1(b) the discriminating layer (2) is characterised by high gas selectivity, thereby providing the main functionality of the GSM. The protective layer (4) in FIG. 1(b) is intended to reduce possible mechanical damage to the discriminating layer (2) and further layer (3), e.g. during handling or use of the GSM. The protective layer (iv) (4) typically has high gas permeance and durability, thereby protecting the DL from mechanical damage.

Preferably support layer (i) comprises a porous sheet material (“PSM”). The PSM provides the GSM with mechanical strength and reduces the likelihood of the GSM being damaged when used at high pressures and/or temperatures.

Preferred PSMs include, for example, woven and non-woven fabrics and combinations thereof.

The PSM may be constructed from, for example, any suitable polymer or natural fibre. Examples of such polymers include polysulfones, polyethersulfones, polyimides, polyetherimides, polyamides, polyamideimides, polyacrylonitrile, polycarbonates, polyesters, polyacrylates, cellulose acetate, polyethylene, polypropylene, polyvinylidenefluoride, polytetrafluoroethylene, poly(4-methyl 1-pentene) and especially polyacrylonitrile.

Many suitable PSMs are commercially available. Alternatively one may prepare the PSM using techniques generally known in the art for the preparation of such materials. In one embodiment one may prepare the optional PSM by curing curable components, e.g. in an analogous manner to that used to prepare membranes while ensuring the pores of the PSM are too large to discriminate between different gases.

Preferably layer (iii) is in contact with layer (ii). Typically layer (ii) is sandwiched between and in direct contact with layers (i) and (iii).

When layer (iv) is present, typically layer (iii) is sandwiched between and in direct contact with layers (ii) and (iv).

Optionally the PSM may have been subjected to a corona discharge treatment, glow discharge treatment, flame treatment, ultraviolet light irradiation treatment or the like, e.g. for the purpose of improving its wettability and/or adhesiveness.

As PSM one may use, for example, an ultrafiltration membrane, e.g. a polysulfone ultrafiltration membrane, cellulosic ultrafiltration membrane, polytetrafluoroethylene ultrafiltration membrane, polyvinylidenefluoride ultrafiltration membrane and especially polyacrylonitrile ultrafiltration membrane. Asymmetric ultrafiltration membranes may also be used, including those comprising a porous polymer membrane (preferably of average thickness 10 to 150 μm, more preferably 20 to 100 μm) and optionally a woven or non-woven fabric support.

The PSM is preferably as thin as possible, provided that it provides the desired structural strength to the GSM.

Preferably the PSM comprises pores having an average diameter of 0.001 to 10 μm, preferably 0.01 to 1 μm (i.e. before the PSM has been converted into a GSM). Preferably the PSM comprises pores which, at the surface, have an average diameter of 0.001 to 0.1 μm, preferably 0.005 to 0.05 μm. The average pore diameter may be determined by, for example, viewing the surface of the PSM by scanning electron microscopy (“SEM”) or by cutting through the PSM and measuring the diameter of the pores within the porous support, again by SEM, then calculating the average. The porosity at the surface of the PSM may also be expressed as a % porosity, i.e.

$$\% porosity = 100 \% \times \frac{( area of the surface which is missing due to pores )}{( total surface area )}$$

The areas required for the above calculation may be determined by inspecting the surface of the PSM by SEM before it has been converted into a gas separation membrane. Thus, in a preferred embodiment, the PSM has a % porosity >1%, more preferably >3%, especially >10%, more especially >20%.

Alternatively the porosity of the PSM may be characterised by measuring the N₂ gas flow rate through the PSM. Gas flow rate can be determined by any suitable technique, for example using a Porolux™ 1000 device, available from Porometer.com. Typically the Porolux™ 1000 is set at the maximum pressure (about 34 bar) and one measures the flow rate (L/min) of N₂ gas through the PSM under test. The N₂ flow rate through the PSM at a pressure of about 34 bar for an effective sample area of 2.69 cm² (effective diameter of 18.5 mm) is preferably >1 L/min, more preferably >5 L/min, especially >10 L/min, more especially >25 L/min. The higher of these flow rates are preferred because this reduces the likelihood of the gas flux of the resultant GSM being reduced by the PSM. The above pore sizes and porosities refer to the PSM before it has been converted into the GSM of the present invention.

The porosity of layer (i) (as a whole) may be expressed as a CO₂ gas permeance (units are m³ (STP)/m²·s·kPa). When the GSM is intended for use in gas separation then layer (i) (as a whole) preferably has a CO₂ gas permeance of 5 to 150×10⁻⁵ m³ (STP)/m²·s·kPa, more preferably of 5 to 100, most preferably of 7 to 70×10⁻⁵ m³ (STP)/m²·s·kPa.

Layer (i) (as a whole) is not gas separation selective as compared to the discriminating layer (ii).

Layer (i) (as a whole) preferably has an average thickness of 20 to 500 μm, preferably 50 to 400 μm, especially 100 to 300 μm.

Preferably layer (i) further comprises a gutter layer (“GL”). When layer (i) comprises a GL, the GL is preferably located between the PSM and the discriminating layer (ii) (in direct contact with the discriminating layer (ii)).

The further layer (iii) may contain M from other sources, and not just from the groups of Formula (1). Thus the “total atomic % of M” (as distinct from the atomic % of M of Formula (1) groups referred to in claim 1) present in the further layer (iii) includes M from all sources, including but not limited to M from the groups of Formula (1). For example, the “total atomic % of M” present in the further layer (iii) includes M from other sources such as from one or more groups of Formula (2):

M-(O—)_{z} Formula (2)
wherein:
M is a metal or metalloid atom;
O is an oxygen atom; and
z has a value of 1, 2 or 3.
   Typically the further layer (iii) comprises groups of Formula (1) and groups of Formula (2).
   Preferably each M independently (in Formula (1) and (2)) is silicon, titanium, zirconium or aluminium. Each M independently (in Formula (1) and (2)) is preferably silicon, titanium, zirconium and/or aluminium.

Preferably the further layer (iii) comprises more than 10 atomic % and less than 50 atomic % of M of Formula (2) groups, especially 12 to 30 atomic % and more especially 13 to 27 atomic % of M of Formula (2) groups, wherein M is as hereinbefore defined. Preferably the further layer (iii) comprises 2 to 9 atomic % of M of Formula (1) groups, more preferably 3 to 8 atomic % of M of Formula (1) groups, wherein M is as hereinbefore defined.

When the further layer (iii) comprises above 10 atomic % of M of Formula (1) groups the gas permeance of the GSM falls or drops significantly and the further layer becomes discriminating too. The further layer (iii) is therefore not separation selective or discriminating between gasses such as CO₂ and CH₄ as compared to the discriminating layer (ii). When the further layer (iii) comprises less than 1.5 atomic % of M of Formula (1) the permeance of the GSM falls significantly.

Preferably the total atomic % of M present in the further layer (iii) (i.e. M from all sources, e.g. from Formula (1) groups+Formula (2) groups) is from 13.5 to 35 atomic %, especially from 15 to 33 atomic % and more especially 16 to 32 atomic %. Preferably the composition of the further layer (iii) is substantially constant throughout its depth. For example, the atomic % of M of Formula (1) groups present in the further layer (iii) varies by less than 25% (more preferably less than 10%, especially less than 5%) relative to the average atomic % of M in the further layer (iii) for at least 80% of the depth of the further layer (iii). As an example, if the average atomic % of M in the further layer (iii) is ‘X %’ then the atomic % of M in the further layer (iii) is preferably from 0.75× to 1.25× for at least 80% of the depth of the further layer (iii) (more preferably 0.9× to 1.1×, especially 0.95 to 1.05×).

The atomic % of M (e.g. derived from Formula (1) groups and from any Formula (2) groups etc.) in the further layer (iii) (and also in the DL (ii)) may be determined using surface analysis equipment, for example by X-ray photoelectron spectroscopy (XPS) (e.g. using GC-IB/XPS Gas cluster ion beam XPS). Such equipment may also be used to determine the atomic % of M at the top-surface and at different depths in and below the surface of the further layer (iii), and any other layers (e.g. the DL or GL, when present). A suitable piece of equipment for performing surface analysis to determine the atomic % of M in the various layers is the VersaProbe II XPS apparatus from Physical Electronics, Inc. (“ULVAC-PHI”). The ULVAC-PHI is preferably set up with monochromated Al K_{α} (1486.6 eV, 15 W25 KV 100 μmφ, raster size 300 μm×300 μm) X-ray source. For charge compensation, low energy electron and Ar ion may be flooded during measurement of the atomic % of M in the various layers. Ar gas cluster beam (5 kV, 20 nA, 2 mm×2 mm) may be used for depth profile analysis. From this analysis, the atomic % of M and any other elements present in the further layer (iii) (e.g. carbon and oxygen) may be measured. At the data point which has the highest atomic % of M, the atomic % of M in the further layer (iii) can be determined. This will include M from all sources such as groups of the Formula (1) or Formula (2) as defined above and the amount of M in each of these groups can be quantified separately. For example, when M is silicon, the atomic % of silicon in Si—(O—)₄ groups and Si—(O—)_{z} groups (wherein z is 1, 2 or 3) can be quantified by this method. In the spectrum of Si2p, the bonding energy at 102.6 eV is defined as being a group of Formula (2), whereas the bonding energy of 103.8 eV is defined as being a group of Formula (1), wherein Formula (1) and Formula (2) are as hereinbefore defined. The area ratio of Si2p at 102.6 eV and at 103.8 eV may be converted to an atomic ratio (atomic %) so that the total of the separated peak components area would correspond to the atomic % of Si.

In one embodiment, the further layer (iii) comprises a substantially constant value of 1.5 to 10 atomic % of M of Formula (1) groups throughout the depth of the further layer (iii). For example atomic % of M of Formula (1) groups present in the further layer (iii) varies by less than 25% relative to the average atomic % of M of Formula (1) groups throughout the depth of the further layer (iii). By building in the further layer (iii) composition with a substantially constant atomic % of Si of Si—(O—)₄ groups between 1.5 and 10% above the DL, the further layer (iii) can be considered not separation selective practically or discriminating between gasses such as for example CO₂ and CH₄ or gasses such as CO₂ and O₂ or between O₂ and N₂. or for example between H₂ and CH₄. Not gas separation selective means in this application that an engineer skilled in the art would not propose the further layer (iii) as source or embodiment for meaningful gas separation of CO₂ and CH₄ or gasses such as CO₂ and O₂ or between O₂ and N₂ or for example between H₂ and CH₄.

The atomic % of M of Formula (1) groups, wherein M is as hereinbefore defined, is the atomic % of M present in the relevant layer in the form of groups of Formula (1). Similarly, the atomic % of M of Formula (2) groups, wherein M is as hereinbefore defined, is the atomic % of M present in the relevant layer in the form of groups of Formula (2).

In one embodiment the further layer (iii) is obtainable or obtained by a process comprising plasma treatment. A suitable plasma treatment process comprises plasma deposition, especially plasma treatment of compounds comprising M such that a further layer (iii) is formed comprising the groups of Formula (1) and optionally also the groups of Formula (2) (each as hereinbefore defined). Preferred plasma treatment processes are performed using precursors under atmospheric pressure in the absence of oxygen and/or air.

The groups of Formula (1), and also groups of Formula (2) when present (each as hereinbefore defined and preferred), are present in layer (iii) but may be present optionally in layer (ii) when the discriminating layer (ii) has also been using a plasma treatment (as described below in more detail).

In one embodiment, further layer (iii) is applied to discriminating layer (ii) by a plasma treatment process using a precursor compound which provides the groups of Formula (1). A carrier gas may be used using noble gass(es) (e.g. argon or helium).
The plasma treatment process for applying layer (iii) to layer (ii) is preferably performed at an energy level in the range of 0.30 to 9.00 J/cm² (and using low pressure or even at (remote) atmospheric plasma treatment).

The plasma treatment process for applying layer (iii) to layer (ii) is preferably performed using a flow rate of argon in the range of 5 to 500 cm³ (STP)/min, more preferably in a range of 50 to 200 cm³ (STP)/min, and particularly preferably in a range of 80 to 120 cm³ (STP)/min. The low pressure plasma treatment is preferably performed at a gas pressure in the range of 0.6 Pa to 100 Pa, more preferably in a range of 1 to 60 Pa, and particularly preferably in a range of 2 to 40 Pa.

When a silicon-containing precursor compound is used in the plasma treatment process this results in the deposition of the further layer (iii) onto layer (ii) as a silica-like top-surface comprising the groups of Formula (1) and usually also groups of Formula (2), both as hereinbefore defined.

The average thickness of further layer (iii) is typically in the range 1 to 1,500 nm, more preferably 5 to 1,000 nm and even more preferably 10 to 500 nm.

According to a second aspect of the present invention there is provided a process for forming a gas separation membrane according to the first aspect of the present invention comprising the steps of:
(a) applying the discriminating layer (ii) to a support layer (i) by a wet coating process, physical vapor deposition process, chemical vapor deposition process, initiated deposition process, an atomic layer deposition process or a plasma treatment process; and
(b) applying further layer (iii) to the discriminating layer (ii) (the DL) by a plasma treatment process; and
optionally (c) applying a protective layer (iv) to the further layer (iii).

In a preferred embodiment, discriminating layer (ii) is applied to support layer (i) by a plasma treatment process, e.g. using a plasma treatment device. The preferred plasma treatment process for applying discriminating layer (ii) to support layer (i) comprises use of an atmospheric pressure glow discharge plasma, for example as described in U.S. Pat. No. 10,427,111, page 40, line 4 to page 41, line 36, which is included herein by reference thereto. For example, support layer (i) may be exposed to an atmospheric pressure glow discharge plasma thereby forming discriminating layer (ii) thereon.

The plasma treatment processes which may be used in step (b) and optionally in step (a) is preferably performed using a plasma treatment apparatus comprising a treatment space and a first electrode and a second electrode in the treatment space for generating an atmospheric pressure glow discharge plasma between the first and second electrode. The electrodes can be provided with a dielectric barrier in various arrangements. In one arrangement the dielectric barrier of at least one electrode is formed by a polymer film or inorganic dielectric. Such as polymer like polyethylene terephthalate (PET), polytetrafluoroethylene (PTFE) or polyethylene (PE) or ceramic such as silica or alumina, or combinations of these, also microporous dielectric materials attached to the electrodes can be used.

In a preferred embodiment, the further layer (iii) is applied to discriminating layer (ii) using atmospheric pressure glow discharge plasma (as plasma treatment process).

As mentioned above, preferably the atomic % of M of Formula (1) groups in the further layer (iii) is substantially constant from the top-surface throughout the depth of the further layer (iii). In order to achieve the substantially constant atomic % of M of Formula (1) groups in the further layer (iii), the manufacturing process for the further layer (iii) preferably differs from that used to make the DL (when a plasma treatment was used to make the DL) in that precursors are used in the presence of noble and inert gasses in the absence of oxygen.

In step (b) the plasma treatment process preferably comprises generating an atmospheric pressure glow discharge plasma in a treatment space comprising layer (i) at an effective power density of 0.03 to 30 W/cm², preferably for less than 120 seconds. Preferably the treatment space is free from oxygen (e.g. the treatment space comprises an oxygen-free inert gas).

In step (a) the plasma treatment process (when this is used) preferably comprises generating an atmospheric pressure glow discharge plasma in a treatment space comprising layer (ii) at an effective power density of 0.1 up to 30 W/cm² preferably for less than 60 seconds. Preferably in that case in step (a) the treatment space comprises an oxygen-rich atmosphere.

Thus it is preferred that both steps (a) and (b) comprise a plasma treatment process wherein step (b) is performed in an atmosphere free-from oxygen and step (a) is performed in an atmosphere comprising oxygen.

The plasma treatment process(es) can be performed using a precursor compound (especially an organosilicon compound). The preferred plasma treatment in step (b) uses a precursor compound. The precursor compound may be included in the treatment space and is preferably performed (in step (b)) at an energy of 0.1 to 10 J/cm².

In a preferred embodiment, the treatment space used in step (b) comprises an atmosphere free of air or oxygen and a power density of 0.1 to 10 J/cm² is used.

In a preferred embodiment, the plasma treatment process used in step (a) and/or step (b) comprises stabilization of an atmospheric pressure glow discharge plasma, e.g. according to any of the methods described in, for example, U.S. Pat. No. 6,774,569 and EP1383359.

In a preferred embodiment the plasma treatment process used in step (b) comprises exposing discriminating layer (ii) to an atmospheric pressure glow discharge plasma, wherein the plasma is stabilized by an inductance and capacitance (LC) matching network, for example as described in EP1917842.

In another embodiment, the further layer (iii) may be applied to layer (ii) (the DL) using a plasma treatment process performed in a low pressure plasma environment, e.g. as described in U.S. Pat. No. 10,427,111.

The plasma treatment apparatus used to perform the plasma treatment step(s) may, in a further embodiment, comprise a transport device for transporting layer (i) (the support layer) or layers (i)+(ii) combined, past the electrode. Also, the transport device may comprise a tensioning mechanism for keeping layer (i) or layers (i)+(ii) in close proximity to the electrode.

In one embodiment, the further layer (iii) is obtainable from one or more precursor compounds which may be included in the treatment space. Precursor compounds which may be used to provide groups of Formula (1) (as hereinbefore defined) and optionally groups of Formula (2) (as hereinbefore defined) include TEOS (tetraethyl orthosilicate), HMDSO (hexamethyldisiloxane), TMOS (tetramethyl orthosilicate), TMCTS (1,3,5,7-tetramethylcyclotetrasiloxane), D4 OMCTS (octamethyl cyclotetrasiloxane), D5 (decamethylcyclopentasiloxane), D6 (dodecamethylcyclohexasiloxane), bis(triethoxysilyl)ethane (BTESE), TPOT (tetrapropylorthotitanate), TEOT (titanium ethoxide), TTIP (titanium tetraisopropoxide) or ZTB (zirconium tetra-tert-butoxide).

A substantially uniform further layer (iii) may be prepared using the atmospheric pressure glow discharge equipment as described in EP1917842 using an inductance and capacitance (LC) matching network. In this embodiment the further layer (iii) preferably has an average thickness in the range 1 to 1,000 nm and even more preferred in the range from 10 to 500 nm.

Thus in a preferred embodiment of the process according to the second aspect of the present invention, step (a) comprises applying the discriminating layer (ii) to the support layer (i) by a plasma treatment process and step (b) comprises applying the further layer (iii) to the discriminating layer (ii) by a plasma treatment process.

As mentioned above, layer (i) preferably comprises a PSM and optionally a gutter layer (“GL”). The GL, when present, is preferably attached to the PSM (e.g. coated thereon). Furthermore, the GSM optionally comprises a PL. When the GSM does not contain a PL it may still be used for gas separation or it may be sold as an item of commerce for customers to apply their own, bespoke PL, if they so wish. The optional GL and PL are permeable to gasses and typically have a low ability to discriminate between gases. The GL and PL, when present, preferably comprise a polymer resin, especially a polysiloxane. Preferred polysiloxane(s) present in or as the GL and/or PL are poly(dimethyl)siloxanes, e.g. a polymer comprising an —Si—(CH₃)₂—O— repeat unit.

The GL, when present, preferably has an average thickness in the range 50 to 2400 nm, preferably in the range 150 to 800 nm and especially in the range 200 to 650 nm.

The PL, when present, preferably has an average thickness in the range 10 to 10,000 nm, more preferably in the range 50 to 5,000 nm and especially in the range 100 to 3,000 nm.

Preferred GL and PL each independently comprise groups which are capable of bonding to a metal, for example by covalent bonding, ionic bonding and/or by hydrogen bonding, preferably by covalent bonding. The identity of such groups depends to some extent on the chemical composition of the GL/PL and the identity of the metal, but typically such groups are selected from epoxy groups, oxetane groups, carboxylic acid groups, amino groups, hydroxyl groups, vinyl groups, hydrogen groups and thiol groups. More preferably the GL and PL each independently comprise a polymer having carboxylic acid groups, epoxy groups or oxetane groups, vinyl groups, hydrogen groups, or a combination of two or more of such groups. Such a polymer may be formed on the support by a process comprising the curing of a radiation-curable or heat-curable composition, especially a curable (e.g. radiation-curable) composition comprising a polymerisable dialkylsiloxane. The latter option is useful for providing GLs and PLs comprising dialkylsiloxane groups, which are preferred.

The polymerisable dialkylsiloxane which may be present in the optional GL and PL is preferably a monomer comprising a dialkylsiloxane group or a polymerisable oligomer or polymer comprising dialkylsiloxane groups. For example, one may prepare the GL and/or PL from a radiation-curable composition comprising a partially crosslinked, radiation-curable polymer comprising dialkylsiloxane groups, as described in more detail below. Typical dialkylsiloxane groups are of the formula —{O—Si(CH₃)₂}n- wherein n is at least 1, e.g. 1 to 100. Poly(dialkylsiloxane) compounds having terminal vinyl groups are also available and these may be incorporated into the GL and/or PL by the curing process.

In one embodiment the GL is free from groups of formula Si—C₆H₅.

In one embodiment the PL is free from groups of formula Si—C₆H₅.

Irradiation of the radiation-curable composition (sometimes referred to as “curing” in this specification) to form the optional GL or PL may be performed using any source which provides the wavelength and intensity of radiation necessary to cause the radiation-curable composition to polymerise and thereby form the GL on the PSM or form the PL on further layer (iii). For example, electron beam, ultraviolet (UV), visible and/or infrared radiation may be used to irradiate (cure) the radiation-curable composition, with the appropriate radiation being selected to match the components of the composition.

The optional GL and PL are preferably each independently obtained from curing a curable composition comprising:
(1) 0.5 to 25 wt % of radiation-curable component(s), at least one of which comprises dialkylsiloxane groups;
(2) 0 to 5 wt % of a photo-initiator; and
(3) 70 to 99.5 wt % of inert solvent.

Preferably the curable composition used to prepare the optional GL/PL has a molar ratio of titanium:silicon of at least 0.0005, more preferably 0.001 to 0.1 and especially 0.003 to 0.03.

The radiation-curable component(s) of component (1) typically comprise at least one radiation-curable group. Radiation curable groups include ethylenically unsaturated groups (e.g. (meth)acrylic groups (e.g. CH₂═CR¹—C(O)— groups), especially (meth)acrylate groups (e.g. CH₂═CR¹—C(O)O— groups), (meth)acrylamide groups (e.g. CH₂═CR¹—C(O)NR¹— groups), wherein each R¹ independently is H or CH₃) and especially oxetane or epoxide groups (e.g. glycidyl and epoxycyclohexyl groups).

The amount of radiation-curable component(s) present in the curable composition used to prepare the optional GL and/or the optional PL (i.e. component (1)) is preferably 1 to 20 wt %, more preferably 2 to 15 wt %. In a preferred embodiment, component (1) of the curable composition used to prepare the optional GL and/or PL comprises a partially crosslinked, radiation-curable polymer comprising dialkylsiloxane groups.

The function of the inert solvent (3) is to provide compositions with a viscosity suitable for the particular method used to apply the curable composition to the support. For high speed application processes one will usually choose an inert solvent of low viscosity. Examples of suitable inert solvents are mentioned above in relation to preparation of the polymer sheet.

The amount of inert solvent (3) present in the curable composition used to prepare the optional GL and/or PL (i.e. component (3)) is preferably 70 to 99.5 wt %, more preferably 80 to 99 wt %, especially 90 to 98 wt %.

Inert solvents are not radiation-curable.

The compositions may contain other components, for example surfactants, surface tension modifiers, viscosity enhancing agents, biocides and/or other components capable of co-polymerisation with the other ingredients.

The function of the discriminating layer (ii) is to discriminate between gases, separating a feed gas mixture into a permeate which passes through the GSM and a retentate which does not pass through the GSM. The permeate and retentate typically comprise the same gases as the feed gas mixture, but one is enriched in at least one of the gases present in the feed gas and the other is depleted in that same gas. The average thickness of the discriminating layer is preferably in the range 1 nm to 2 μm, more preferably in the range 3 nm to 1 μm, especially in the range 5 to 200 nm.

The DL (layer (ii)) may be any DL capable of discriminating between the gases which are desired to be separated (e.g. separating CO₂ from CH₄). Preferably the discriminating layer (ii) has a selectivity for one of the gases to be separated over another of the gases to be separated of at least 10. In contrast, the further layer (iii) preferably has a selectivity for one of the gases to be separated over another of the gases to be separated of far below 10, e.g. less than 8 or even far less than 5.

The discriminating layer (ii) may be prepared (in a wet coating process) from a composition comprising a polymer, an inert solvent and optionally an initiator. The inert solvent may be any solvent capable of dissolving the polymer used to form the discriminating layer (ii). Suitability of the solvent is determined by the properties of the polymer and the concentration desired. Suitable solvents include water, C₅₋₁₀ alkanes, e.g. cyclohexane, heptane and/or octane; alkylbenzenes, e.g. toluene, xylene and/or C₁₀₋₁₆ alkylbenzenes; C₁₋₆ alkanols, e.g. methanol, ethanol, n-propanol, isopropanol, n butanol, sec-butanol, tert-butanol, n-pentanol, cyclopentanol and/or cyclohexanol; linear amides, e.g. dimethylformamide or dimethylacetamide; ketones and ketone-alcohols, e.g. acetone, methyl ether ketone, methyl isobutyl ketone, cyclohexanone and/or diacetone alcohol; ethers, e.g. tetrahydrofuran and/or dioxane; diols, preferably diols having from 2 to 12 carbon atoms, e.g. pentane-1,5-diol, ethylene glycol, propylene glycol, butylene glycol, pentylene glycol, hexylene glycol and/or thiodiglycol; oligo- and poly-alkyleneglycols, e.g. diethylene glycol, triethylene glycol, polyethylene glycol and/or polypropylene glycol; triols, e.g. glycerol and/or 1,2,6 hexanetriol; mono-C₁₋₄-alkyl ethers of diols, preferably mono-C₁₋₄-alkyl ethers of diols having 2 to 12 carbon atoms, e.g. 2-methoxyethanol, 2-(2-methoxyethoxy)ethanol, 2-(2 ethoxyethoxy)-ethanol, 2-[2-(2-methoxyethoxy)ethoxy]ethanol, 2-[2-(2-ethoxyethoxy)-ethoxy]-ethanol and/or ethyleneglycol monoallylether; cyclic amides, e.g. 2-pyrrolidone, N-methyl-2-pyrrolidone, N-ethyl-2-pyrrolidone, caprolactam and/or 1,3-dimethylimidazolidone; cyclic esters, e.g. caprolactone; sulphoxides, e.g. dimethyl sulphoxide and/or sulpholane; and mixtures comprising two or more of the foregoing, particularly a mixture comprising methyl ethyl ketone and tetrahydrofuran.

The discriminating layer (ii) preferably comprises as polymer a polyimide, cellulose acetate, polyethyleneoxide or polyetherimide, especially a polyimide comprising trifluoromethyl groups. A particularly preferred discriminating layer (ii) comprises a polyimide comprising groups of the Formula (3):

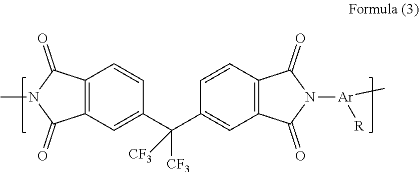

wherein Ar is an aromatic group and R is a carboxylic acid group, a sulphonic acid group, a hydroxyl group, a thiol group, an epoxy group or an oxetane group.

Polyimides comprising trifluoromethyl groups may be prepared by, for example, the general methods described in U.S. Pat. Reissue No. 30,351 (based on U.S. Pat. No. 3,899,309), U.S. Pat. Nos. 4,717,394 and 5,085,676.

In one embodiment of the process according to the second aspect of the present invention the discriminating layer (ii) is prepared by plasma surface treatment of the support layer (i) including a polysiloxane GL as described above in step (a) above and as described in WO2022/207359 by applicant which is included herein by reference thereto and as a result it comprises a gradient of atomic % of M of Formula (1) groups and a surface atomic % of M of Formula (1) above 10 for the discriminating layer.

The GSMs of the present invention may be packaged and supplied commercially to companies who assemble gas separation modules, e.g. for their own use or for onward sale.

According to a third aspect of the present invention there is provided a gas separation module comprising one or more gas separation membranes according to the first aspect of the present invention.

The gas separation modules of the present invention preferably further comprise a feed carrier and a permeate carrier, optionally wound onto a perforated tube.

Preferred gas separation modules include a spiral type module, a hollow fiber type module, a pleat type module, a tubular type module, and a plate and frame type module.

According to a fourth aspect of the present invention there is provided use of a gas separation membrane according to the first aspect of the present invention or a gas separation module according to the third aspect of the present invention for separating gases and/or for purifying a feed gas.

The gas separation membranes and modules of the present invention are particularly useful for the separation of a feed gas containing a target gas into a gas stream rich in the target gas and a gas stream depleted in the target gas. For example, a feed gas comprising polar and non-polar gases may be separated into a gas stream rich in polar gases and a gas stream depleted in polar gases. In many cases the membranes have a high permeability to polar gases, e.g. CO₂, H₂S, NH₃, SOₓ, and nitrogen oxides, especially NOx, relative to non-polar gases, e.g. alkanes, H₂, and N₂. Thus the polar gas is preferably CO₂, H₂S, NH₃, SOₓ, a nitrogen oxides or two or more thereof in combination. The non-polar gas is preferably N₂, H₂, an alkane or two or more thereof in combination.

Preferably the polar and non-polar gases are gaseous when at 25° C.

The target gas may be, for example, a gas which has value to the user of the module or element and which the user wishes to collect. Alternatively the target gas may be an undesirable gas, e.g. a pollutant or ‘greenhouse gas’, which the user wishes to separate from a gas stream in order to meet a product specification or to protect the environment.

The modules and GSMs of the present invention are particularly useful for purifying natural gas (a mixture which predominantly comprises methane) by removing polar gases (CO₂, H₂S); for purifying synthesis gas; and for removing CO₂ from hydrogen and from flue gases. Flue gases typically arise from fireplaces, ovens, furnaces, boilers, combustion engines and power plants. The composition of flue gases depend on what is being burned, but usually they contain mostly nitrogen (typically more than two-thirds) derived from air, carbon dioxide (CO₂) derived from combustion. Flue gases also contain a small percentage of pollutants such as particulate matter, carbon monoxide, nitrogen oxides and sulphur oxides. Recently the separation and capture of CO₂ has attracted attention in relation to environmental issues (global warming).

The modules and GSMs of the present invention are particularly useful for separating the following: a feed gas comprising CO₂ and N₂ into a gas stream richer in CO₂ than the feed gas and a gas stream poorer in CO₂ than the feed gas; a feed gas comprising CO₂ and CH₄ into a gas stream richer in CO₂ than the feed gas and a gas stream poorer in CO₂ than the feed gas; a feed gas comprising CO₂ and H₂ into a gas stream richer in CO₂ than the feed gas and a gas stream poorer in CO₂ than the feed gas, a feed gas comprising H₂S and CH₄ into a gas stream richer in H₂S than the feed gas and a gas stream poorer in H₂S than the feed gas; and a feed gas comprising H₂S and H₂ into a gas stream richer in H₂S than the feed gas and a gas stream poorer in H₂S than the feed gas.

The modules and GSMs of the present invention are particularly useful for separating ‘dirty’ a feed gas comprising a polar gas, a non-polar gas and a hydrocarbon containing at least two (e.g. 2 to 7) carbon atoms into a permeate gas and a retentate gas, one of which is enriched in the polar gas and the other of which is depleted in the polar gas.

The invention will now be illustrated by the following, non-limiting examples in which all parts and percentages are by weight unless specified otherwise.

### EXAMPLES

In these Examples the performance of the GSMs was measured using a multilayer structure comprising the gas separation membrane under test (having the support layer (i) facing the 05^{TH}100S sheet below), 05TH100S sheet and 42369 sheet having the general structure shown Table 1.

The 05TH100S sheet and 42369 sheet are described in more detail below.

TABLE 1
Multilayer structures comprising GSMs
Gas Separation Membrane under test

05TH100S sheet
42369 sheet

In the Examples, the feed gas used had the composition shown in Table 2 below:

TABLE 2

| | Components | | |
|---|---|---|---|
| Feed gas | CO₂ | CH₄ | n-C₄H₁₀ |
| vol % | 13.00 | 86.00 | 1.00 |

The performance properties of the GSMs of the present invention and the Comparative GSMs were measured using the multilayer structure shown in Table 1 by the following techniques:

### (A) Permeance:

The feed gas having the composition described in Table 2 above was passed through the multilayer structure shown in Table 1 under test at 40° C. at a gas feed pressure of 6000 kPa. The flux of CO₂ and n-C₄H₁₀ and CH₄ through the multilayer structures shown in Table 1 was measured using a gas permeation cell with a measurement diameter of 2.0 cm.

The permeance (Qᵢ) of CO₂ and n-C₄H₁₀ and CH₄ was determined after 5 minutes continuous use of the multilayer structures shown in Table 1 (which comprise the GSM under test) using the following equation:

$${Q}_{i} = ( {θ}_{Perm} \cdot {X}_{Perm , i} ) / ( A \cdot ( {P}_{Feed} \cdot {X}_{Feed , l} - {P}_{Perm} \cdot {X}_{Perm , i} ) )$$

wherein:
Qᵢ=Permeance of the relevant gas (i.e. i is CO₂ or C₄H₁₀ or CH₄) (m³ (STP)/m²·kPa·s);
θ_{Perm}=Permeate flow rate (m³ (STP)/s);
X_{Perm,i}=Volume fraction of the relevant gas in the permeate gas;
A=Membrane area (m²);
P_{Feed}=Feed gas pressure (kPa);
X_{Feed,i}=Volume fraction of the relevant gas in the feed gas;
P_{Perm}=Permeate gas pressure (kPa); and

STP is standard temperature and pressure, which is defined here as 25.0° C. and 1 atmosphere pressure (101.325 kPa).

The (Qᵢ) can be determined by 1 GPU=1×10⁻⁶ cm³ (STP)/(s·cm²·cmHg).

The permeance of CO₂ above 150 GPU was evaluated as good and below or equal to 150 GPU was evaluated as comparative result and compared to the inventive examples as not good.

### (B) Selectivity

The selectivity (CO₂/C₄H₁₀ and CO₂/CH₄; αCO₂/C₄H₁₀ and αCO₂/CH₄) of each multilayer structure shown in Table 1 under test for the gas mixture described in Table 2 was calculated from QCO₂ and Qn-C₄H₁₀ calculated as described above based on following equations:

αCO₂/n-C₄H₁₀=QCO₂/Qn-C₄H₁₀;

αCO₂/CH₄=QCO₂/QCH₄

wherein QCO₂, QCH₄ and Qn-C₄H₁₀ were determined by the method described in step (A) above.

An αCO₂/n-C₄H₁₀ value of 100 or higher was deemed to be acceptable and an αCO₂/n-C₄H₁₀ value of below 100 was deemed to be unacceptable.

An αCO₂/CH₄ value of 15 or higher was deemed to be acceptable and an αCO₂/CH₄ value of below 15 was deemed to be unacceptable.

### (C) Gutter Layer Thickness

The thickness of gutter layers was determined by cutting through the support layer (i) and measuring the thickness of the gutter layer from the sheet material outwards by SEM.

(D)—The atomic % of M of Formula (1) Groups

The atomic % of M of Formula (1) groups in the DLs and FLs was determined using the general method described above in the description using a X-ray photoelectron spectroscope using GC-IB/XPS Gas cluster ion beam XPS apparatus from Physical Electronics, Inc. (“ULVAC-PHI”). The ULVAC-PHI is set up with monochromated Al K_{α} (1486.6 eV, 15 W 25 KV 100 μmφ, raster size 300 μm x300 μm) X-ray source. For charge compensation, low energy electron and Ar ion may be flooded during measurement of the atomic % of M in the various layers. Ar gas cluster beam (5 kV, 20 nA, 2 mm×2 mm) is used for depth profile analysis.

### Preparation of the Gas Separation Membranes

The following materials were used to prepare the GSMs and multilayer structures:
PAN is a porous sheet material having an average thickness of 170-180 μm comprising a PET nonwoven support (140-150 μm thick) having a porous polyacrylonitrile layer. PAN was obtained from Microdyn-Nadir GmbH, Germany, under the trade name UA100T.
HI is a non-woven porous sheet material called Hi-star 05TH-100 of average thickness 150 μm from Hirose paper MFG Co. Ltd. (i.e. a support layer (i))
X-22-162C is a dual end reactive silicone having carboxylic acid reactive groups, a viscosity of 220 mm²/s and a reactive group equivalent weight of 2,300 g/mol, from Shin-Etsu Chemical Co., Ltd. (MWT 4,600) (I is an integer).

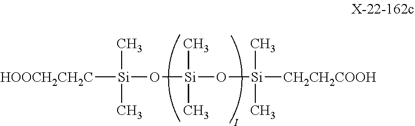

DBU is 1,8-diazabicyclo[5.4.0]undec-7-ene from Sigma Aldrich.
UV-9300 is SilForce™ UV-9300 from Momentive Performance Materials Holdings having an epoxy equivalent weight of 950 g/mole oxirane (MWT 9,000, determined by viscometry)) (m and n are integers).

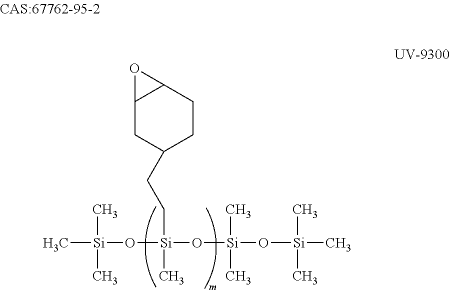

I0591 is 4-isopropyl-4′-methyldiphenyliodoniumtetrakis(pentafluorophenyl) borate (C₄₀H₁₈BF₂₀I) from Tokyo Chemical Industries N.V. (Belgium)

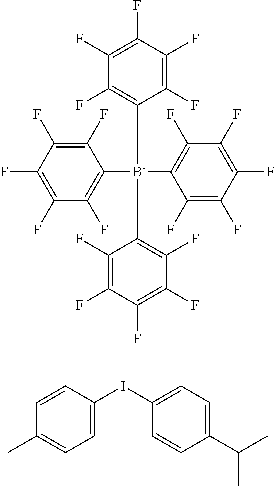 [SMILES: Fc1c(F)c(F)c(C[B-](c2c(F)c(F)c(F)c(F)c2F)(c2c(F)c(F)c(F)c(F)c2F)c2c(F)c(F)c(F)c(F)c2F)c(F)c1F ; Cc1ccc([I+]c2ccc(C(C)C)cc2)cc1]

Ti(OiPr)₄ is titanium (IV) isopropoxide from Dorf Ketal Chemicals (MWT 284).
n-Heptane is n-heptane from Brenntag Nederland BV.
MEK is 2-butanone from Brenntag Nederland BV.
CA is cellulose acetate CA-398-3 from Eastman Chemicals.
FOR is formamide from Thermo Scientific Acros
AC is acetone from Sigma-Aldrich 179124
MAL is maleic acid M0375 from Sigma-Aldrich
PI is 6FDA-TeMPDx/DABAy, x/y=20/80; obtained from FUJIFILM Corporation, having the following structure:

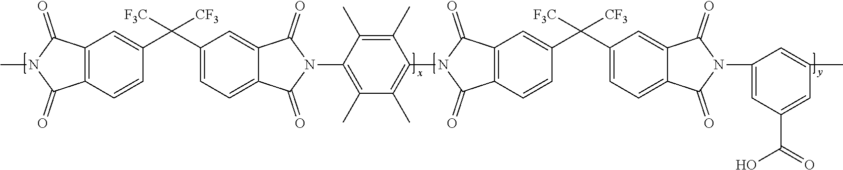

HMDSO is hexamethyl disiloxane (98%) supplied by Merck
   which is used a precursor for the inventive further layer (iii).
MIBK is methylisobutyl ketone from Brenntag Nederland BV
DIOX is 1,3-dioxolane from Brenntag Nederland BV.
APTMS is 3-trimethoxysilyl propan-1-amine from Sigma Aldrich.
05TH100S sheet is a sheet material from Hirose paper manufacturing (a wet-laid polyester non-woven/average thickness 100 μm/average weight 100 g/m²/average density 0.93 g/cm³).
42369 sheet is a macroporous sheet material from Guilford (a fabric made from polyethylene terephthalate and epoxy resin/average thickness of 0.3 mm/60 wpi (wales per 2.54 cm)/59 cpi (courses per 2.54 cm)).

### Preparation of Gas Separation Membranes

### Stage a) Preparation of a Partially Cured Polymer (“PCP Polymer”)

The components UV-9300, X-22-162C and DBU were dissolved in n-heptane in the amounts indicated in Table 3 and maintained at a temperature of 91° C. for 168 hours. The resultant polymer (PCP Polymer) had a Si content (meq/g polymer) of 12.2 and the resultant solution of PCP Polymer had a viscosity of 125 mPas at 25.0°

TABLE 3
Ingredients used to Prepare PCP Polymer

| Ingredient | Amount (w/w %) |
|---|---|
| UV-9300 (w/w %) | 46.395 |
| X-22-162C (w/w %) | 13.596 |
| DBU (w/w %) | 0.009 |
| n-Heptane (w/w %) | 40.000 |

### Stage b) Preparation of Radiation Curable Composition C

The solution of PCP Polymer arising from the Stage a) was cooled to 20° C. and diluted using n-heptane to give the PCP Polymer concentration indicated in Table 4 below. The solution was then filtered through a filter paper having a pore size of 2.7 μm. The photoinitiator (10591) and a metal complex (Ti(OiPr)₄) were then added in the amounts (wt/wt %) indicated in Table 4 to give Curable Composition C. The amount of Ti(OiPr)₄ present in Curable Composition C corresponded to 55.4 μmol of Ti(OiPr)₄ per gram of PCP Polymer. Also the molar ratio of metal:silicon in Curable Composition C was 0.0065.

TABLE 4
Ingredients of Curable Composition C

| Ingredient | Amount (wt/wt %) |
|---|---|
| PCP Polymer | 10.000 |
| I0591 | 0.105 |
| Ti(OiPr)₄ | 0.226 |
| DBU | 0.001 |
| MEK | 2.008 |
| n-Heptane | 87.660 |

Curable Composition C was used to prepare the gutter layer in the GSMs of Examples 1 and 3 to 8 and Comparative Examples C1, C3 and C4 and the protective layer of Examples 7 to 9 and Comparative examples C1 to C4, as described in more detail below.

Step i. Preparation of the PAN-GL Support Layer (i)

Porous support layer PAN-GL was prepared by applying a curable Composition C to PAN and curing the composition as described below:

Curable Composition C (prepared as described in stage b) above) was applied to PAN (a porous sheet material) by meniscus dip coating at a speed of 10 m/min and the coated porous sheet material was then irradiated at an intensity of 16.8 kW/m (70%) using a Light Hammer LH10 from Fusion UV Systems fitted with a D-bulb. The resultant support layer (i) (PAN-GL) comprised a porous sheet material and a polysiloxane (gutter layer of average dry thickness 600 nm and was used as a GL in Examples 1, 3 to 8 and Comparative Examples C1, C3 and C4. The GL comprised a metal complex (derived from Ti(OiPr)₄) and dialkylsiloxane groups. The average GL thickness was determined by cutting through the support layer (i) and measuring the thickness from the surface of the porous sheet material outwards by SEM in several places and calculating the average.

Thus, as shown in Table 6 below, the porous support in Examples 1 and 3 to 8 and Comparative Examples C1, C3 and C4 was PAN-GL. Examples 2 and 9 and Comparative Example C2 used HI as support layer with no GL

### Step ii.a) Formation of the Discriminating Layer (DL1) by Plasma Treatment (Examples 3 to 7 and Comparative Examples C3 and C4)

In Examples 3 to 7 and Comparative Examples C3 and C4 the discriminating layer DL1 was applied to the support indicated in the second column of Table 6 using the atmospheric plasma device used described in EP1917842, FIG. 5, with carrier gas conditions of an oxygen flow rate of 0.5 dm³ (STP)/min and an argon flow rate of 20 dm³ (STP)/min were set, and then a plasma treatment was performed as an oxygen atom permeating treatment at an input power of 1.75 J/cm². This resulted in DL1 having an average thickness of 60 nm.

The atomic % of M of Formula (1) of DL1 was determined by the method described above and was found to be above 10.

Step ii.b) Preparation of the Discriminating Layers DL2 and DL3 from Compositions DLC2 and DLC3 Respectively

Compositions DLC2 and DLC3 were prepared by mixing the ingredients indicated in Table 5 below:

TABLE 5
Ingredients for Compositions DLC2 and DLC3:

| Ingredient | | |
|---|---|---|
| (wt %) | DLC2 | DLC3 |
| PI | 1.00 | 0 |
| CA | 0 | 24.0 |
| FOR | 0 | 19.0 |
| MAL | 0 | 9.5 |
| AC | 0 | 47.5 |
| APTMS | 0.01 | 0 |
| MIBK | 3.00 | 0 |
| DIOX | 4.99 | 0 |
| MEK | 91.00 | 0 |

Discriminating layers DL2 and DL3 were formed by applying compositions DLC2 and DLC3 respectively to the porous supports indicated in the second column of Table 6 below and then curing the compositions.

The composition DLC3 was coated on top of a HI support (no gutter layer) and dried by evaporating the acetone in dry environment for 18 seconds for Example 2, 9 and Comparative Example C2. The Examples 2, 9 and Comparative Example C2 were then immersed in cold water (about 2° C.), washed with water at room temperature to remove any residual solvents and solvent exchanged (first with isopropyl alcohol and then with hexane). The hexane was then evaporated by dry air at 25° C. to obtain the dry HI-D3 intermediate, composite membranes for Examples 2 and 9 and Comparative Example C2 having an average total thickness of 2 μm.

The composition DLC2 was coated on top of the PAN-GL support prepared in step (i) by a meniscus dip coating at 10 m/min coating speed and dried for Examples 1 and 8 and Comparative Example C1 to obtain a dry 100 nm thick discriminating layer DL2, as measured by SEM.

Step iii) Formation of the Inventive Further Layer (iii) for Examples 1 to 9

Samples of the intermediate composite membranes comprising the support and DL indicated in Examples 1 to 9, second and third columns, were each independently exposed to an atmospheric pressure glow discharge (APG) plasma using precursor HMDSO. The device used for the exposure was as described in EP1917842. The precursor mass flow supplied via controlled evaporation unit was 1.0 g/hr HMDSO. The precursor vapours were diluted in argon process carrier gas. The flow of the process gas was 20 dm³ (STP)/min. The applied plasma power density was varied from 0.2 W/cm² for Example 5, 0.4 W/cm² for Examples 1 to 3 and Examples 6 to 9 and 0.8 W/cm² for Example 4 to obtain different, further layers (iii) having differing average thicknesses/amounts of M of Formula (1). The average thickness of the resultant further layer (iii) depended on the exposure times: 5 seconds for Example 5, 13 seconds for Examples 1 to 3 and 6 to 9 and 15 seconds for Example 4 and the average thicknesses were ascertained for each gas separation membrane by cutting through the GSM and measuring the average thickness of each layer using a scanning electron microscope. The atomic % of M of Formula (1) groups in further layer (iii) and in the PLs (in the Examples 7 to 9 and Comparative Examples C1 to C4) was determined, including two measurements on 10 and 20 nm depth and an averaged value was determined then included in Table 6.

### Step iv). Formation of Protective Layer for Examples 7 to 9 and Comparative Examples C1 to C4

In Comparative Examples C1 to C4, the PLs indicated in Table 6, column 5, were obtained by applying Curable Composition C having the formulation described above to the composite of layers (i) and (ii) by a meniscus dip coating at a speed of 10 m/min. The coated intermediate membranes were then cured by irradiating at an intensity of 24 kW/m using a Light Hammer LH10 from Fusion UV Systems fitted with a D-bulb. The average thicknesses of each protective layer in the Comparative Examples indicated in Table 6, column 5, was 2,400 nm for C1 to 03 and 100 nm for 04, as measured by SEM.

Examples 7 to 9 contained a PL (on top of the inventive further layer (iii)) which was also prepared from Curable Composition C in an analogous manner to that described above for the PL in Comparative Examples C1 to C4. These protective layers also had an average thickness of 2,400 nm, as measured by SEM.

Furthermore the permeance (in GPU) and the selectivity (CO₂/CH₄) of all GSMs was determined using the methods described above and the results are shown in Table 6.

TABLE 6
Summary of the membrane structure and membrane performance

| | | | Further | | Protective | | |
|---|---|---|---|---|---|---|---|
| | | | Layer (iii) | | layer | | |
| | | | Atomic % of | | Atomic % of | | |
| | | | M of | | M of | | |
| | | | Formula (1) | | Formula (1) | | |
| | | DL layer (ii) | groups/ | | groups/ | | |
| | Support layer | (average | average | | average | Permeance | Selectivity |
| example | (i) | thickness) | thickness | | thickness | [GPU] | CO₂/CH₄ |
| 1 | PAN-GL | DL2 | 4%/100 | nm | 0 | 180 | 25 |
| | | (100 nm) | | | | | |
| 2 | HI (no GL) | DL3 | 4%/100 | nm | 0 | 250 | 15 |
| | | (2 μm) | | | | | |
| 3 | PAN-GL | DL1 | 4%/100 | nm | 0 | 250 | 30 |
| | | (60 nm) | | | | | |
| 4 | PAN-GL | DL1 | 8%/50 | nm | 0 | 220 | 35 |
| | | (60 nm) | | | | | |
| 5 | PAN-GL | DL1 | 3%/110 | nm | 0 | 280 | 28 |
| | | (60 nm) | | | | | |
| 6 | PAN-GL | DL1 | 4%/100 | nm | 0 | 300 | 25 |
| | | (60 nm) | | | | | |
| 7 | PAN-GL | DL1 | 4%/100 | nm | <1%/ | 230 | 30 |
| | | (60 nm) | | | 2,400 nm | | |
| 8 | PAN-GL | DL2 | 4%/100 | nm | <1%/ | 160 | 26 |
| | | (100 nm) | | | 2,400 nm | | |
| 9 | HI (no GL) | DL3 | 4%/100 | nm | <1%/ | 227 | 16 |
| | | (2 μm) | | | 2,400 nm | | |

| | | | | | | |
|---|---|---|---|---|---|---|
| C1 | PAN-GL | DL2 | 0 | <1%/ | 88 | 24 |
| | | (100 nm) | | 2,400 nm | | |
| C2 | HI (no GL) | DL3 | 0 | <1%/ | 64 | 15 |
| | | (2 μm) | | 2,400 nm | | |
| C3 | PAN-GL | DL1 | 0 | <1%/ | 76 | 32 |
| | | (60 nm) | | 2,400 nm | | |
| C4 | PAN-GL | DL1 | 0 | <1%/ | 82 | 31 |
| | | (60 nm) | | 100 nm | | |

By comparing the results in Table 6 for GSMs of the present invention with the Comparative GSMs comprising the same DL one can see that the permeance of the GSMs was very high when the further layer (iii) was present. Furthermore, the permeance remained very high even when layer (iii) was coated with a PL, as shown in Examples 7 to 9.

1. A gas separation membrane comprising the following layers:
(i) a support layer;
(ii) a discriminating layer;
(iii) a non gas separation selective further layer, wherein the further layer comprises groups of Formula (1):
M-(O—)ₓ Formula (1)
wherein:
each M independently is a metal or metalloid atom;
O is an oxygen atom; and
each x independently has a value of at least 4; and
(iv) optionally a protective layer;
wherein:
(a) the support layer (i) and the further layer (iii) are on opposite sides of discriminating layer (ii); and
(b) the further layer (iii) comprises 1.5 to 10 atomic % of M of Formula (1) groups, wherein M is as hereinbefore defined.

2. The gas separation membrane according to claim 1 wherein the further layer (iii) is formed by a plasma deposition process using precursors in the absence of oxygen.

3. The gas separation membrane according to claim 1 wherein the discriminating layer (ii) comprises more than 10 atomic % and less than 50 atomic % of M of Formula (1) groups.

4. The gas separation membrane according to claim 1 wherein the further layer (iii) has an average thickness in the range 1 nm to 1,500 nm.

5. The gas separation membrane according to claim 2 wherein the further layer (iii) has an average thickness in the range 5 nm to 1,000 nm.

6. The gas separation membrane according to claim 1 wherein the further layer (iii) comprises an average value for the atomic % of M of Formula (1) groups which is substantially constant throughout its depth.

7. The gas separation membrane according to claim 1 which comprises a protective polysiloxane layer (iv).

8. The gas separation membrane according to claim 7 wherein the protective layer (iv) has an average thickness in the range 10 to 10,000 nm.

9. A process for forming a gas separation membrane according to claim 1 which comprises the steps of:
(a) applying the discriminating layer (ii) to the support layer (i) by a wet coating process, physical vapor deposition process, chemical vapor deposition process, initiated deposition process or atomic layer deposition process or a plasma enhanced chemical deposition process; and
(b) applying the further layer (iii) to the discriminating layer (ii) by a plasma treatment process; and optionally
(c) applying a protective layer (iv) to the further layer (iii).

10. The process according to claim 9 wherein step (b) is performed by a plasma treatment process in the presence of one or more of the following precursor compounds: teraethyl orthosilicate, hexamethyldisiloxane, tetramethyl orthosilicate, 1,3,5,7-tetramethylcyclotetrasiloxane, octamethyl cyclotetrasiloxane, decarnethylcyclopentasiloxane, dodecamethylcyclohexasiloxane, bis(triethoxysilyl)ethane, tetrapropylorthotitanate, titanium ethoxide, titanium tetraisopropoxide or zirconium tetra-tert-butoxide.

11. The process according to claim 9 wherein step (b) is performed in an atmosphere free from oxygen.

12. The process according to claim 9 wherein step (a) comprises applying the discriminating layer (ii) to the support layer (i) by a plasma treatment process and step (b) comprises applying the further layer (iii) to the discriminating layer (ii) by a plasma treatment process in an atmosphere free from oxygen and in the presence of one or more of the following precursor compounds: tetraethyl orthosilicate hexamethyldisiloxane tetramethyl orthosilicate 1,3,5,7-tetramethylcyclotetrasiloxane, octamethyl, cyclotetrasiloxane, decamethylcyclopentasiloxane, dodecamethylcyclohexasiloxane, bis(triethoxysilyl)ethane, tetrapropylorthotitanate, titanium ethoxide, titanium tetraisopropoxide or zirconium tetra-tert-butoxide.

13. The process according to claim 12 wherein step (a) provides discriminating layer (ii) having more than 10 atomic % and less than 50 atomic % of M of Formula (1) groups and step (b) provides the further layer (iii) having 1.5 to 10 atomic % of M of Formula (1) groups.

14. A gas separation module comprising a gas separation membrane according to claim 1.

15. (canceled)
